(19) United States
(12) Patent Application Publication
(10) Pub. No.: US 2005/0149439 A1
(43) Pub. Date: Jul. 7, 2005

(54) Transaction Method and System Using an Issued Transaction Number for Verification of a Transaction

(76) Inventor: DANIEL SUISA, Jakarta (ID)

Correspondence Address: DANIEL SUISA, JL. WALET PERMAI 4/33, PANTAL INDAH KAPUK, JAKARTA, 14470, ID

(21) Appl. No.: 10/707,720

(22) Filed: Jan. 7, 2004

(51) Int. Cl. G06F 17/60

(52) U.S. Cl. 705/44

(57) ABSTRACT

A system and method for performing transactions using transaction codes is described. An issuer apparatus issues transaction codes which are unique for particular types of transactions to a customer and stores the issued transaction codes in a database. A transaction apparatus selects a transaction code from the issued transaction codes and associates the transaction code with a document to perform a transaction. The transaction apparatus then performs the transaction using the document with the associated transaction code. A verification means of the issuer apparatus verifies the transaction by performing a comparison between the issued transaction code stored in the database and the transaction code associated with the document. The issuer apparatus modifies the transaction code in the database after positive verification of the transaction.

### BACKGROUND OF INVENTION

The invention relates to secure transactions and more specifically relates to the issuance of a transaction number by an institution allowing a customer to perform a transaction.

Prior art transaction methods and systems using hardcopy forms generally require the forms to be provided by vendors or service providers.

For instance, for payment transactions using checks, the checks are typically provided to the customers by their banks. When the checks run out, a customer must request new checks from the bank and wait for some time until the physical checks are printed and issued to the customer. The customer might not be able to make additional check payment transactions until finally receiving the new checks. From the customer's point of view, the unavailability of the check may cause a lost opportunity for making a transaction. From the bank's point of view, the need to provide checks is an extra business cost.

Another example of this difficulty can be found in the transfer of funds. In funds transfer transactions, customers often must go to the bank in person and perform the transaction using a fund transfer form provided by the bank. From the customer's point of view, the need to go to the bank in person, especially during office hours, can be very inconvenient and is generally a waste of time. From the bank's point of view, the need to provide fund transfer forms is again an extra business cost which includes at least the cost for providing the office space, the cost of hiring the officer to serve the customer, and the cost for providing the hardcopy form.

Several methods and systems for using electronic payments to improve payment systems have been disclosed in the prior art. However, the existing methods and systems are inefficient and require the transmission of large amounts of data between the parties.

It would be desirable to provide a method and system so that banks would not need to print and issue hardcopy forms and so that customers would not need to waste time waiting for and submitting such forms.

In particular it would be desirable to provide a method and system so that banks would not need to print and issue checks and so that customers would not need to wait for ordered checks.

It would further be desirable to provide a method and system so that banks would not need to print and issue fund transfer forms and so that customers would not need to go to the bank to transfer funds.

It would further be desirable to implement such methods and systems electronically using electronic rather than hardcopy forms. Thus, it would also be desirable to provide a method and system to perform efficient and effective electronic transactions.

### SUMMARY OF INVENTION

The present invention provides a method and system for performing a transaction using an issued transaction number. The transaction can be performed using a hardcopy form and/or an electronic medium.

Initially, one or more transaction numbers are assigned and issued by an institution to a customer. The issuance of the transaction number(s) can be based on the request of the customer or the initiative of the institution. The transaction number(s) can be a serial number(s) or a specific number(s).

Next, a transaction is performed by the customer using the issued transaction number. The transaction can be a payment, an instruction, a request, a notification, or any communication between the customer and the institution.

Accordingly, the transaction is verified by the institution or an authorized third party based on the issued transaction number and the signature of the customer and/or a unique identity of the customer.

More generally the invention can be described as a system and method for performing transactions using transaction codes. An issuer apparatus issues transaction codes which are unique for particular types of transactions to a customer and stores the issued transaction codes in a database. A transaction apparatus selects a transaction code from the issued transaction codes and associates the transaction code with a document to perform a transaction. The transaction apparatus then performs the transaction using the document with the associated transaction code. A verification means of the issuer apparatus verifies the transaction by performing a comparison between the issued transaction code stored in the database and the transaction code associated with the document. The issuer apparatus modifies the transaction code in the database after positive verification of the transaction.

### BRIEF DESCRIPTION OF DRAWINGS

FIG. 1 is a flow chart illustrating the method of the present invention.

FIG. 2 is a diagrammatic view of a payor/payee apparatus for performing the transaction using the issued transaction number of FIG. 1.

FIG. 3 is a diagrammatic view of a payor bank apparatus for issuing the transaction number to the customer and verifying the transaction of FIG. 1.

FIG. 4 is a functional diagram of the present invention illustrating its use with paper and electronic checks and fund transfer requests.

FIG. 5 is a flow chart illustrating in more detail the steps of performing the transaction using the issued transaction number and verifying the transaction of FIG. 1 for paper checks.

FIGS. 6A-B show an exemplary paper check before and after being filled according to the embodiment FIG. 5.

FIG. 7A is a flow chart illustrating in more detail the steps of performing the transaction using the issued transaction number and verifying the transaction of FIG. 1 for electronic checks.

FIGS. 7B-D illustrate several combinations of payors and payees in the embodiment of FIG. 7A.

FIGS. 8A-B show the display of the payor apparatus of FIG. 2 before and after an electronic check is generated while performing the method of FIG. 7A.

FIG. 9 shows an example of electronic check data transmitted from the payor apparatus to the payee apparatus while performing the method of FIG. 7A.

FIG. 10 shows an electronic check generated by the payor apparatus and sent to the payee apparatus while performing the method of FIG. 7A and displayed on the payee apparatus of FIG. 2.

FIG. 11A-B shows the display of the payee apparatus of FIG. 2 for clearing the received electronic check while performing the method of FIG. 7A.

FIG. 12 shows an example of an electronic check data for clearing the check and which is transmitted from payee apparatus to payee bank apparatus while performing the method of FIG. 7A.

FIG. 13 is a functional diagram of an embodiment of electronic check confirmation process used with the method of FIG. 7A.

FIG. 14 is a functional diagram of an embodiment of the method of FIG. 7A allowing a payee to use the received electronic check signed by the payor to subsequently pay another payee.

FIG. 15 is a flow chart illustrating an embodiment of the method of FIG. 1 allowing a fund transfer transaction using an electronic fund transfer request.

FIG. 16 is a functional diagram showing the implementation of the method for electronically transferring funds of FIG. 15.

FIGS. 17A-B show the display of the payor apparatus of FIG. 2 before and after an electronic fund transfer request form is filled and signed using the implementation of FIG. 15.

FIG. 18 shows an example of electronic fund transfer request data transmitted from a payor apparatus to a payor bank apparatus while performing the method of FIG. 15.

FIG. 19 shows an embodiment using the issued transaction number in the generation of a digital signature.

### DETAILED DESCRIPTION

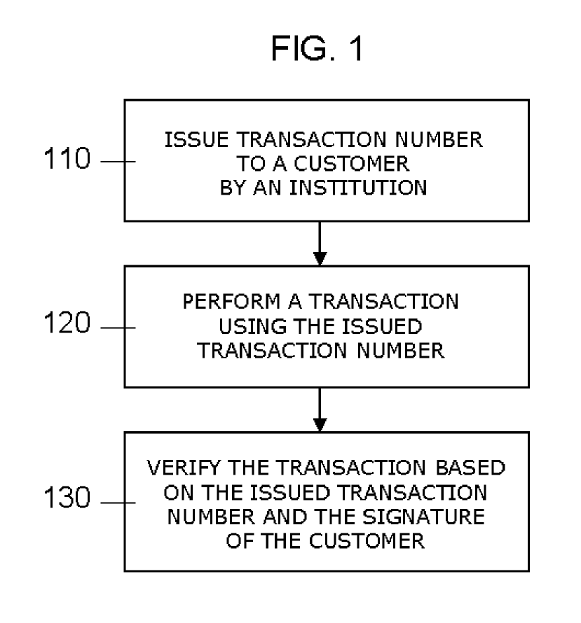

The present invention is first described in general with reference to FIG. 1.

Step 110 is the transaction number issuance step. In this step, at least one transaction number is assigned and issued by an institution to a customer. The issuance of transaction numbers can be in response to a request from the customer or can be initiated by the institution. The transaction numbers can be serial numbers or specific numbers. The specific numbers can be numbers generated based on the customer's identity such account number, name, birth date, etc. The transaction numbers can be more generally referred to as transaction codes since they can include numbers and/or letters and/or other symbols. When the institution is a bank, the transaction numbers can be linked to or generally associated with at least one account number of the customer within the bank.

The transaction numbers should be unique for each transaction performed by a particular customer. In other words, no two transaction numbers issued to a customer should be the same. The transaction numbers can consecutively numbered, for example. This provides added security against forgery by preventing a potential foregoer from copying a transaction number and using it for a later fraudulent transaction since during a verification process it can be determined that the forged transaction number has already been used.

Step 120 is the transaction step. In this step, the transaction is performed by the customer using the transaction number issued in Step 110. The transaction can be a payment, an instruction, a request, a notification, or any communication between the customer and the institution.

Step 130 is the transaction verification step. In this step, the transaction is verified by the institution or an authorized third party based on the issued transaction number and the signature of the customer.

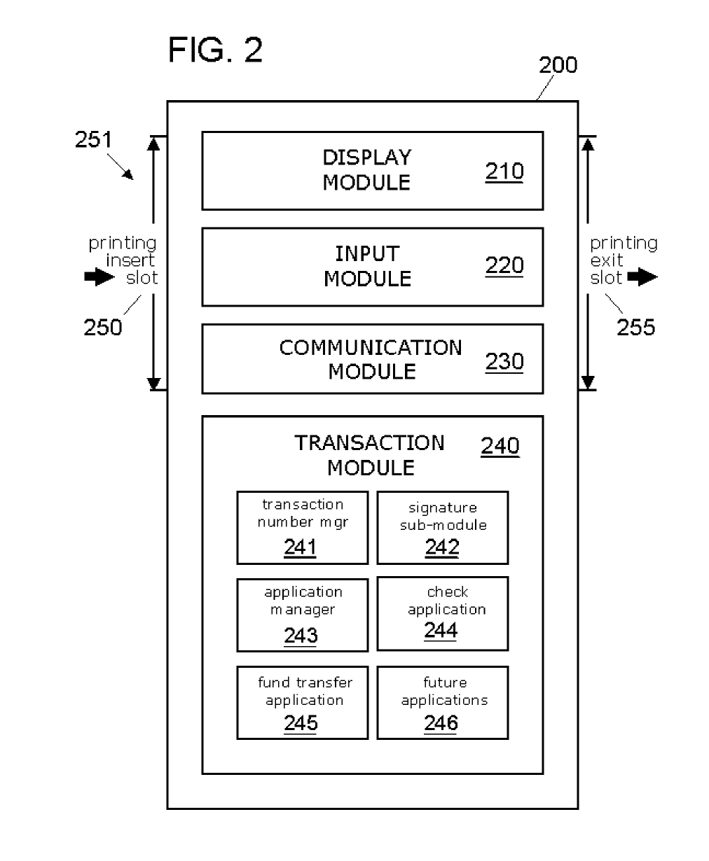

FIG. 2 shows an exemplary transaction “payor” apparatus 200 which can also serve as a payee apparatus for implementing the invention. The apparatus 200 can be a cellular phone, a pda, a personal computer, or any portable handheld electronic device for an individual user, and a larger computer system for a corporate user. The apparatus 200 described herein is preferably a cellular phone, which can be configured with at least: a display module 210, an input module 220, a communication module 230, and a transaction module 240. The transaction module 240 can be configured with at least: a transaction number manager 241 for storage and maintenance of the issued transaction numbers; a signature generation means 242 for producing a digital signature; an application manager 243 for down-loading, installing, and performing maintenance on existing and new applications; a check application 244 for making payments using electronic checks; a fund transfer application 245 for performing a payment by electronic fund transfer request to payor bank; and a pre-location section 246 for future applications. The transaction module 240 can be implemented using known processors and known memory devices.

For implementation of payment with paper checks, the apparatus 200 can further be configured with a printer 251 for printing the check data and signature to the check paper. Preferably, the printer 251 is incorporated within the apparatus 200 as shown in figure. The printer 251 has an input slot 250 for inserting the check paper or document and an exit slot 255 through which the printed check or document is output.

The signature generation means 242 can use the system and method to generate the digital signature described in U.S. patent application Ser. No. 10/604,885 entitled “System and Method for the Generation and Verification of Signatures Associated with Hardcopy Documents” filed on Aug. 25, 2003 by the same inventor as the present application, and which is hereby incorporated by reference in its entirety into the present application.

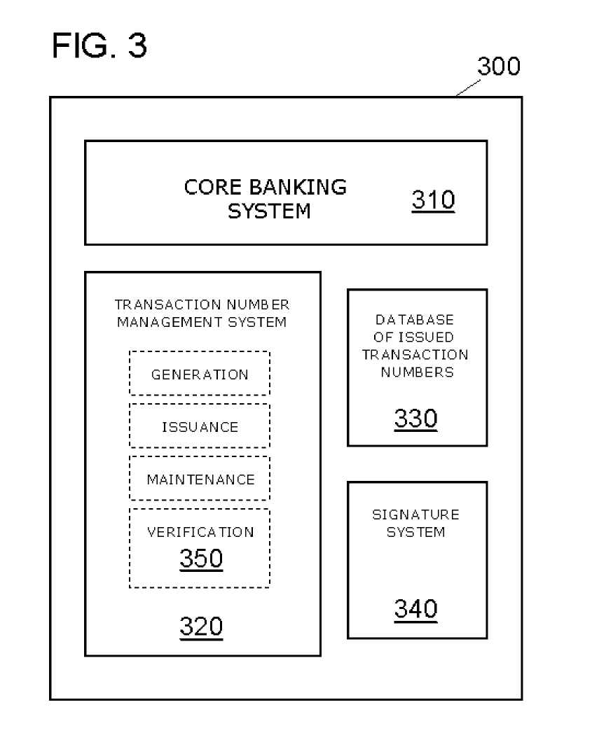

FIG. 3 shows an exemplary payor bank apparatus (issuer apparatus) 300 for implementing the invention. The apparatus 300 can be configured with at least: a core banking system 310; a transaction number management system (in general a “transaction code management system”) 320 for generating, issuing and maintaining the issued transaction numbers, and also for verifying the transaction numbers 350; a database 330 for storage of issued transaction numbers; and a signature system 340 comprising means for verifying digital signatures. The verification of the transaction, which can include the verification of the transaction number, the signature, along with other verification criteria such as the funds availability, the transaction limit, etc., can be controlled by the core banking system 310. The payor bank apparatus 300, like the transaction module 240, can be implemented using known processors and known memory devices.

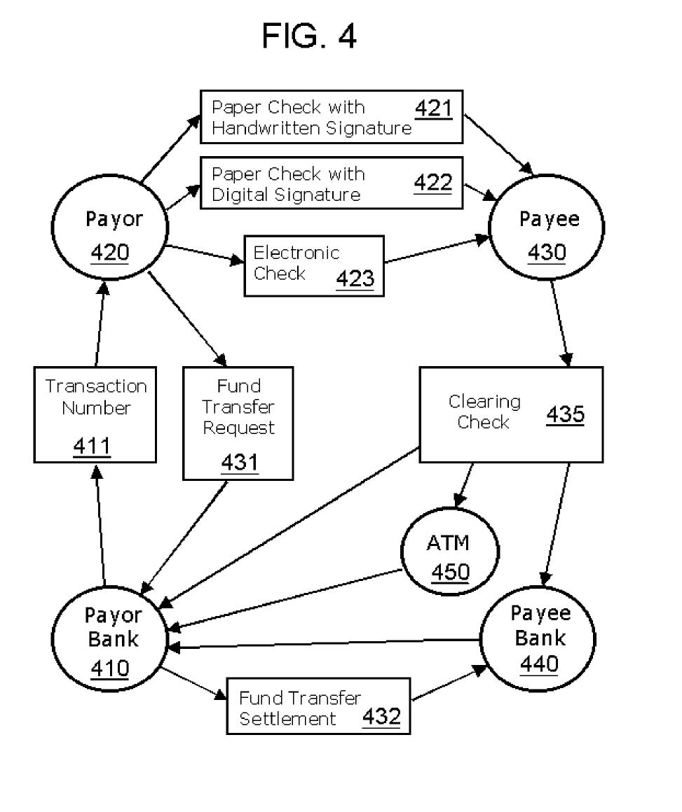

FIG. 4 illustrates the use of the transaction number for several embodiments of the present invention, including with electronic and paper checks, as well as with fund transfer requests.

Initially, a paying, payor or issuer bank 410 assigns and issues one or more transaction numbers (or in general “transaction codes”) 411 to a customer or payor 420. The transaction numbers can be generated and issued to the payor 420 by the transaction number management system 320 of the payor bank apparatus 300 of FIG. 3. The issued transaction numbers 411 are then stored in the database 330 and in a file stored and maintained by the transaction number manager 241 of the apparatus 200 of FIG. 2. The transaction numbers generated and issued to each customer or payor 420 for a specific type of transaction should be unique relative to each other and should not be repeated for a particular type of transaction. For example, if the transaction is a check payment, then the transaction numbers issued to the customer for making check payments should all be different from each other. However, in some embodiments, transaction numbers issued to a customer for making two different types of transactions, for example check payments and fund transfers, can be repeated.

Moreover, a series of transaction numbers can be issued to a customer. For example, a series of numbers from 100 to 110 can be issued to the customer. The number 100 can be used for a check payment, the number 101 used for a fund transfer, the number 102 for a check, the number 103 for another type of transaction, and so forth.

In the case of the series of serial numbers 100 to 110, in one embodiment the apparatus 300 does not need to store all the numbers, but can instead just store the starting number (100) of the series and the ending number of the series (110), for example.

In another embodiment the transaction numbers are specific numbers which are generated using a specific mathematical formula. Customer account numbers can be used with the mathematical formula to generate the transaction numbers. Other reference numbers can additionally be used with the mathematical formula to generate the transaction numbers. In this embodiment, rather than storing the generated transaction numbers in the database 330, the reference numbers and/or customer account numbers used to generate the transaction numbers are stored in the database 330. An example of this embodiment uses the equation:
TN=RN+AN
where TN is the transaction number, RN is the reference number and AN is an account number. If, for example, AN is “100000” and RN is “111”, then the transaction number, TN, is “100111”. The TN “100111” is issued to the customer and stored in the customer apparatus 200. However, the reference number RN, rather than the transaction number TN, is stored in the database 330. When the apparatus 300 receives the transaction number TN “100111” for verification, the RN “111” is retrieved from the database 330 and TN is recalculated by adding RN to AN to get a new number “100111” for comparison.

The transaction number(s) 411 can be issued at the time it is needed or can be issued and stored for later use. The request and the issuance of the transaction number(s) can be done through any electronic communication method such as a wireless SMS (short messaging service), a wireless MMS (multimedia messaging service), e-mail, or an existing banking facility, whichever appropriate, depending on whether the customer is an individual or a corporation.

The issued transaction number(s) 411 can then be used by the payor 420 for performing transactions. Several examples of transactions are described hereinafter, but it should be emphasized that the invention is not limited to these particular types of transactions.

One example is a payment transaction using a paper check. The paper used for the check can be a paper document provided by the payor himself (i.e. the check paper is not supplied to the payor by the payor bank 410). In a preferred embodiment, the document is a piece of paper without customer-specific information printed thereon. The format of the check paper obtained by the payor can be standardized and publicly sold through convenience or stationary stores, for example. The check can be signed with the payor's handwritten signature 421 or with the payor's digital signature 422. In the case of the digital signature 422, the signature can be directly printed onto the check using the printer 251 built into the apparatus 200 or can be manually copied from the display module 210 of the apparatus 200 and written by the payor onto the check. The various ways of generating and applying digital signatures to checks is described in greater detail in U.S. patent application Ser. No. 10/604,885 entitled “System and Method for the Generation and Verification of Signatures Associated with Hardcopy Documents” incorporated by reference above.

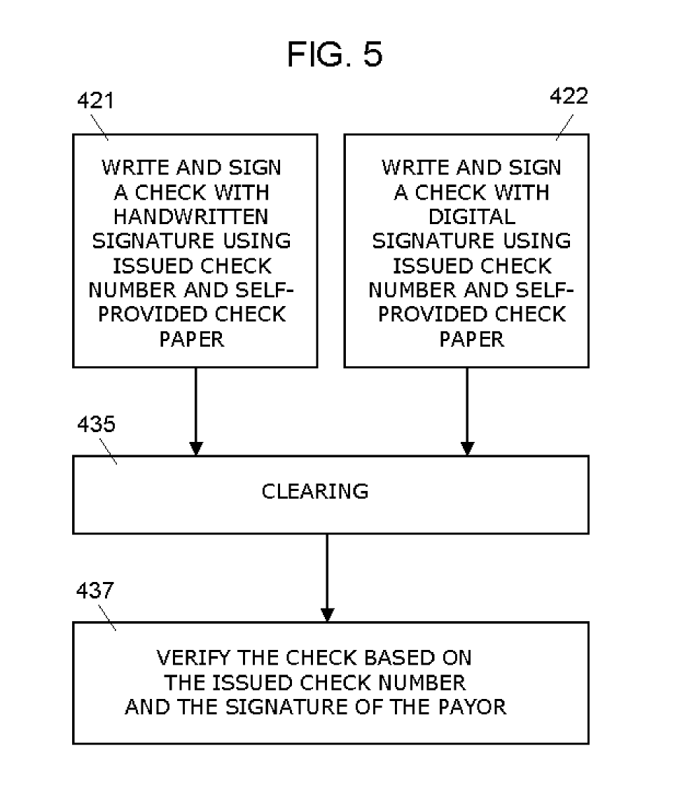

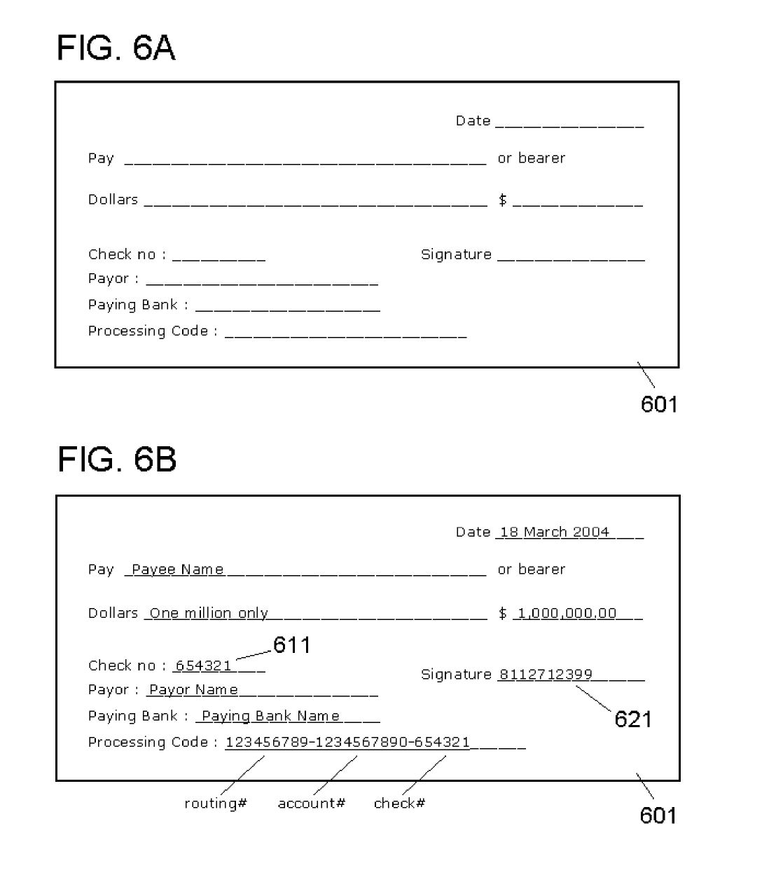

FIG. 5 is a flow chart of the method of the invention as applied to hard-copy paper checks. FIGS. 6A and 6B show an example of a paper check 601 before and after being filled in according to the present invention. In this case the issued transaction number 411 pre-stored in the apparatus 200 can serve as a check number 611. Fixed check data such as the payor name, paying bank name, routing number and payor account number can be pre-stored in the apparatus 200, while the variable check data such as the date, amount and payee name can be input into the apparatus 200. The printer of the apparatus 200 can be used to print the check data onto the self-provided check paper 601. When a digital signature 621 is used for signing the check, the signature generation means 242 of apparatus 200 can be used to generate the digital signature 621 and the generated signature is then printed onto the check paper along with the check data (again this can be done using the method and apparatus of U.S. patent application Ser. No. 10/604,885, see above).

Next, the check can be cleared by the payee 430 at a check clearing Step 435 at a payee bank 440 or an ATM 450 or directly at the payor bank 410. At Step 437 the paper check is verified by the payor bank 410 based on the issued check number (transaction number) recorded in the database 330 of the apparatus 300 and a signature 621 of the payor. The used transaction number in the database can then be flagged or deleted. By flagging the unique transaction number, extra security is provided to prevent the same transaction number from being used more than once. This helps prevent a potential foregoer from copying a transaction number and using it for a later fraudulent transaction. When the received signature is a digital signature, it can be automatically verified by the signature system 340. A computerized handwritten signature system can also be employed to automatically verify the handwritten signature. Upon verification, the check settlement is completed.

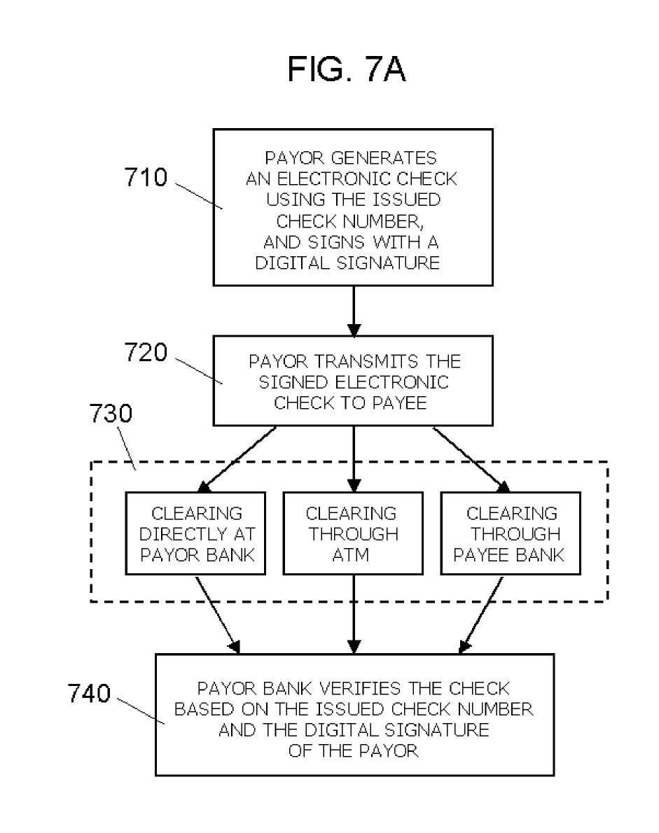

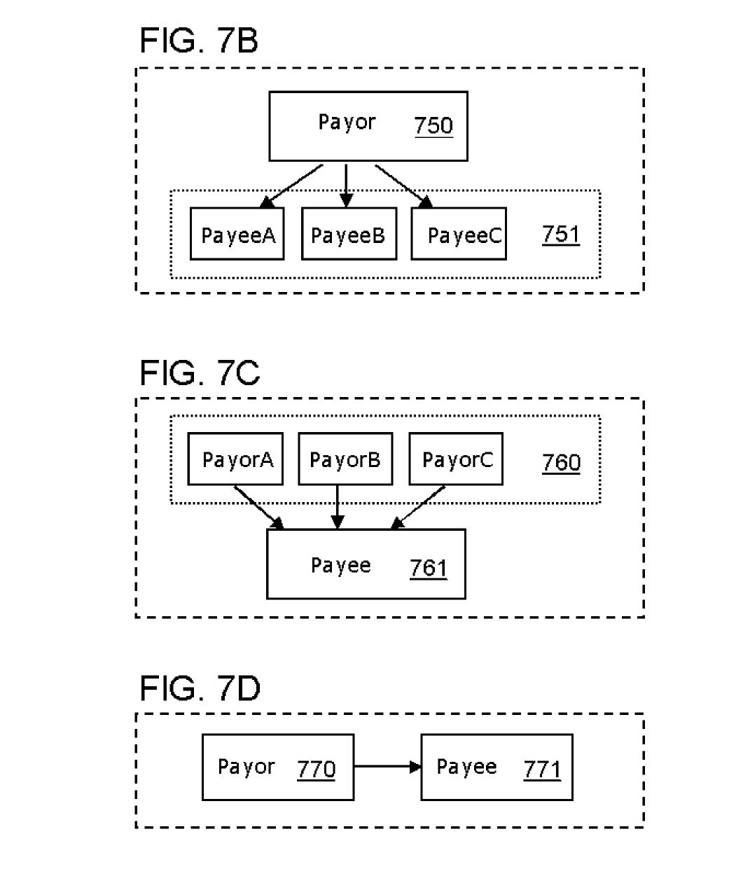

Another embodiment of the present invention provides for payment transactions using an electronic check 423. FIG. 7A is a flow chart of the method of the invention as applied to electronic checks.

FIG. 7B illustrates an embodiment where a payor 750 sends out electronic checks to multiple payees 751. The payor 750 might be a large corporation broadcasting a number of electronic checks to its employees when distributing the payroll, or to its suppliers for payments.

FIG. 7C illustrates an embodiment where multiple payors 760 send out electronic checks to a payee 761. The payors 760 might be customers paying their bills owed to a utility company or retailer who is the payee 761.

FIG. 7D illustrates an embodiment where a single payor 770 pays a single payee 771. The payor 770 and payee 771 might be individuals or different companies, for example.

It should be noted that the scenarios of FIGS. 7B, 7C and 7D can also apply to the embodiment which uses hardcopy paper checks 601 rather than the electronic checks 423. Furthermore, for the paper check embodiments 421, 422 of FIG. 4, the payor 420 and payee 430, along with the in between transactions, can be replaced by the scenarios of FIGS. 7B, 7C and 7D as an embodiment of the invention for use with paper checks 601.

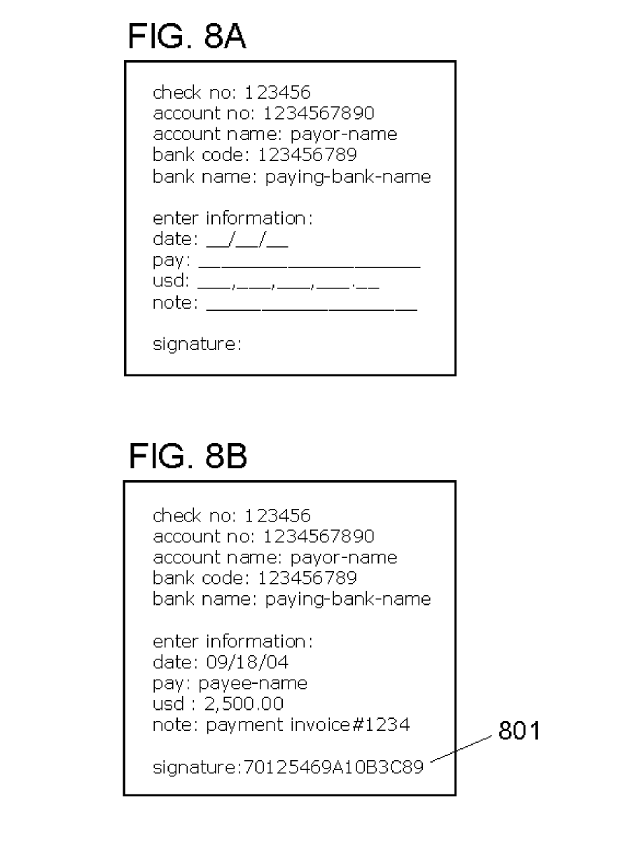

Returning to FIG. 7A, Step 710 illustrates the step of generating the electronic check 423. First, the payor 420 activates the transaction module 240 of the apparatus 200, and selects the check application 244 for generating the electronic check. The display module 210 of the apparatus 200 displays the information of FIG. 8A to prompt the payor to input the indicated information. The displayed data such as the check number, account number, account name, bank code (routing number) and bank name is all data which is pre-stored in the apparatus 200. The pre-stored issued transaction number 411 can again serve as the check number. The indicated information to be input by the payor can include the date, payee, amount and a note, for example. Having input the required information, a digital signature of the payor 420 is generated by the signature generation means 242 based on the issued check number and the check data as described in more detail in U.S. patent application Ser. No. 10/604,885 (see above). The transaction number 411 is used to generate the digital signature 801 shown in FIG. 8B. FIG. 8B shows the display after the digital signature is generated and other information has been input.

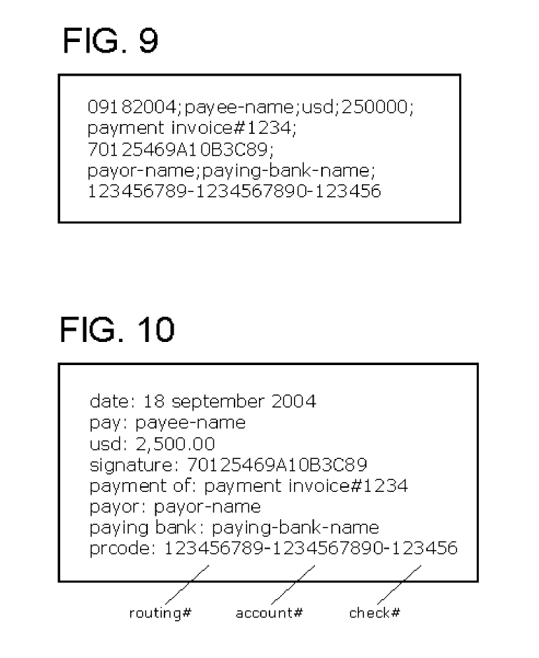

Step 720 is the step of transmitting the generated electronic check from the payor 420 to a payee 430. This step can include any of the scenarios of FIGS. 7B, 7C and 7D. The signed electronic check is transmitted through the communication module 230 of the payor apparatus 200. The transmission of the electronic check from the payor apparatus to the payee apparatus is preferably done through a wireless SMS (short messaging service). FIG. 9 shows exemplary check data transmitted from the payor apparatus to payee apparatus, in which the character is used as a field separator. Upon receiving the electronic check 423, the payee apparatus 200 displays the information of FIG. 10 to show the received electronic check 423.

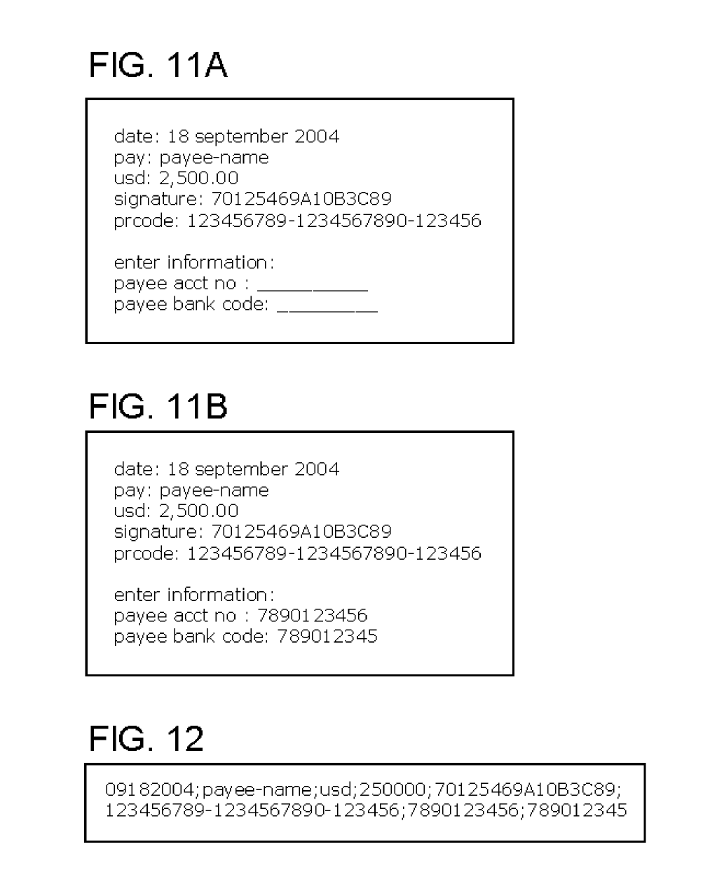

Step 730 is the step of presenting the received electronic check for clearing. This step is the same as the step 435 of FIG. 4 when applied to electronic checks. The payee 430 activates the transaction module 240 of the apparatus 200 and selects the check application 244 for clearing the electronic check 423. The display module 210 of the apparatus 200 displays the information of FIG. 11A to prompt the payee to input the indicated information such as the payee account number and the payee bank code. Other required information can be pre-stored in the apparatus. Moreover, different account information from more than one bank can be pre-stored and can be selected when needed rather than manually re-entering the information each time. Having filled in the required information as shown in FIG. 11B, the electronic check is transmitted to the payee bank 440 for clearing. FIG. 12 shows exemplary check data transmitted from the payee apparatus to a payee bank apparatus, in which the semi-colon “;” symbol is used as a field separator. The transmission of the check from the payee apparatus to the payee bank apparatus is preferably done through a wireless SMS for an individual payee or through a data transfer from-computer-to-computer for a corporate payee. Alternatively, or in the case there is no electronic communication facility, the electronic check can be presented to the payee/payor bank branch by filling the check data into a paper clearing form at the branch. As another alternative, the electronic check can be cleared at an ATM 450 by inputting the check data into the ATM.

Step 740 is the step of verifying the electronic check. The received electronic check is verified by the payor bank 410 based on the received check number and digital signature of the customer/payor. The received check number is verified against the check number (transaction number) recorded in the database 330 of the apparatus 300. The used transaction number in the database can then be flagged or deleted. The received digital signature is verified by the signature system 340. Upon verification, the check settlement is completed.

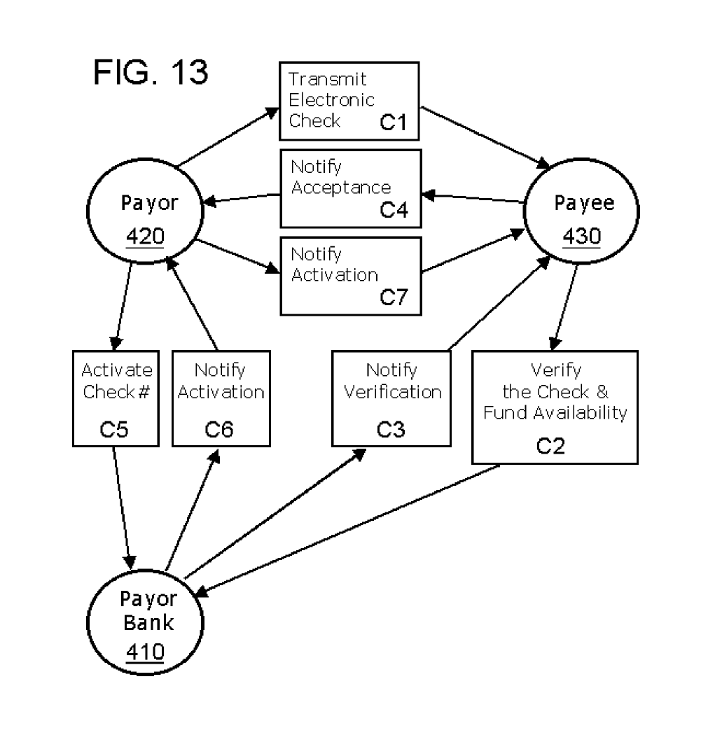

The electronic check embodiment can include additional steps, whenever necessary, for example those shown in FIG. 13. First, the signed electronic check is transmitted from a payor 420 to a payee 430 (Step C1). The payee 430 can, before formally accepting the check as payment, verify with the payor bank 410 the authenticity of the check and the availability of funds (Step C2). Upon a positive notification from the payor bank 410 (Step C3), the payee 430 notifies the payor 420 that he has formally accepted the check as payment (Step C4). The payor 420 then instructs the payor bank 410 to activate the check number/transaction number associated with the check (Step C5) and the payor bank 410 in turn notifies the activation of the check number (Step C6). The payor 420 then notifies the payee 430 that the check is ready for clearing (Step C7). Certain of these steps can be omitted depending on the business rules and/or legal requirements, and also depending upon practical aspects of the transaction. This scheme is particularly useful when applied to checks written for large sums, for example, determined when the system detects an amount on the check above some threshold value. The scheme can be selectively applied so the extra steps are applied to checks having values above the threshold while not being applied to checks with values below the threshold value. This scheme can provide extra protection and confidence in the transaction for both the payor and payee.

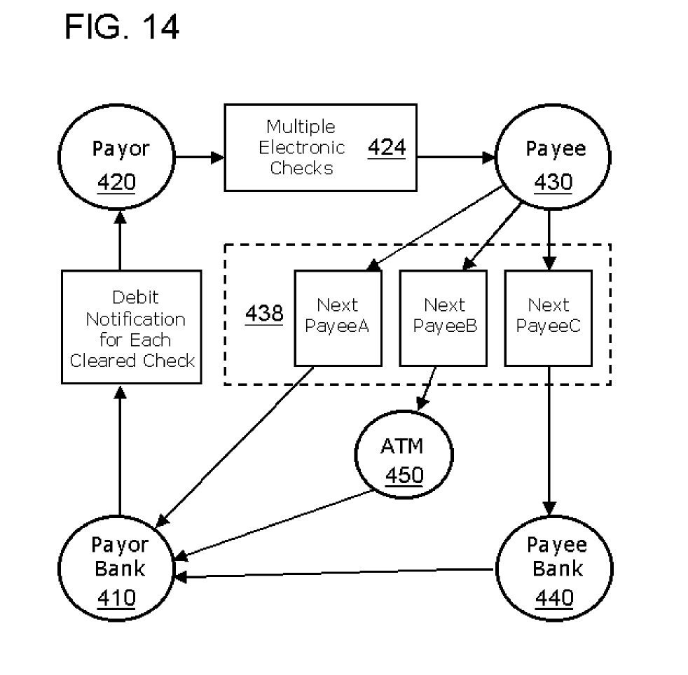

FIG. 14 shows another embodiment also using electronic checks. Here a payor 420 submits multiple checks 424 to a payee 430, and the payee 430 in turn submits the checks to several further payees 438. This situation can occur, for example, when a prize is paid to a winner of a show or an event. The payee 430 can be an MC (master of ceremonies) or another person who is running the show, while the payor 420 can be a person who is financing the show. In this case, the check can be digitally signed by the payor 420 based on the check number and date, for example, where the amount and the payee name can be determined later when such information is available. A data indicator, as described in U.S. patent application Ser. No. 10/604,885 (see above), can be defined to indicate which of the data is used to generate the digital signature. For example: a numeral 1 indicates the check number and the date are used to generate the signature; a numeral 2 indicates the check number, the date and the amount are used to generate the signature, etc. The data indicator can be embedded within the signature code. The data indicator provides the flexibility for a payor to generate digital signatures (to sign the checks) using dynamically selected data or using any available data at the time the check is to be signed and allows the payee to complete the remaining required check data later on prior to paying the check to the further payees 438. The further payees 438 can then each clear their checks as in Step 730 of FIG. 7A.

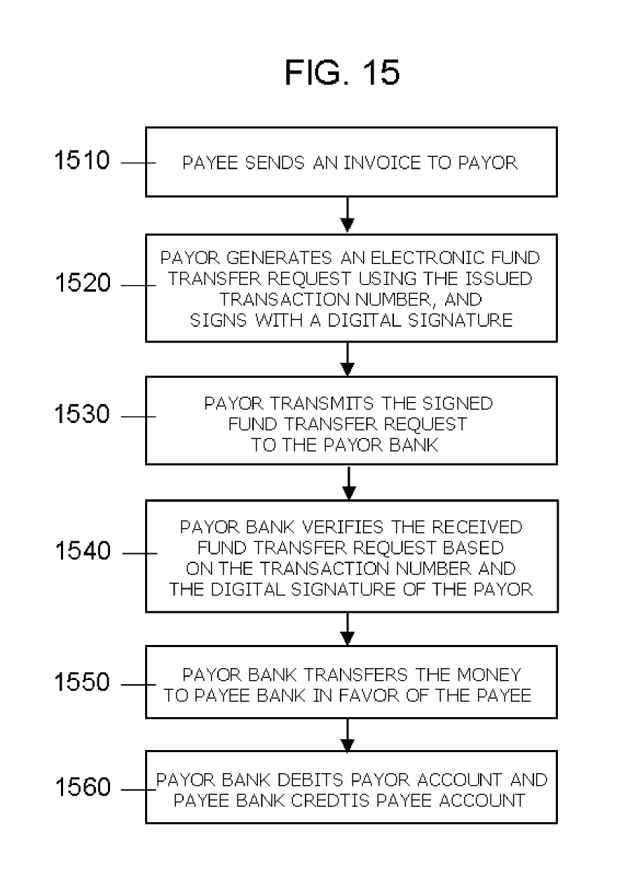

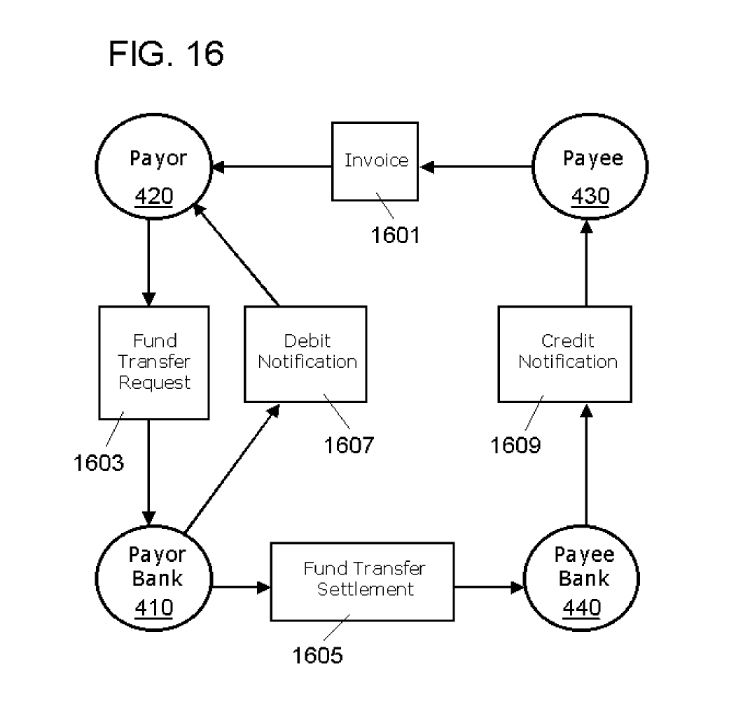

In another embodiment, a payment is made by the payor 420 by performing an electronic payment instruction 431 using the transaction number 411 to request that the payor bank 410 electronically transfer funds 432 to a payee bank 440 in favor the payee 430. FIG. 15 is a flow chart of the embodiment and FIG. 16 is a functional diagram of the embodiment.

At Step 1510, a payee 430 sends an invoice 1601 to a payor 420.

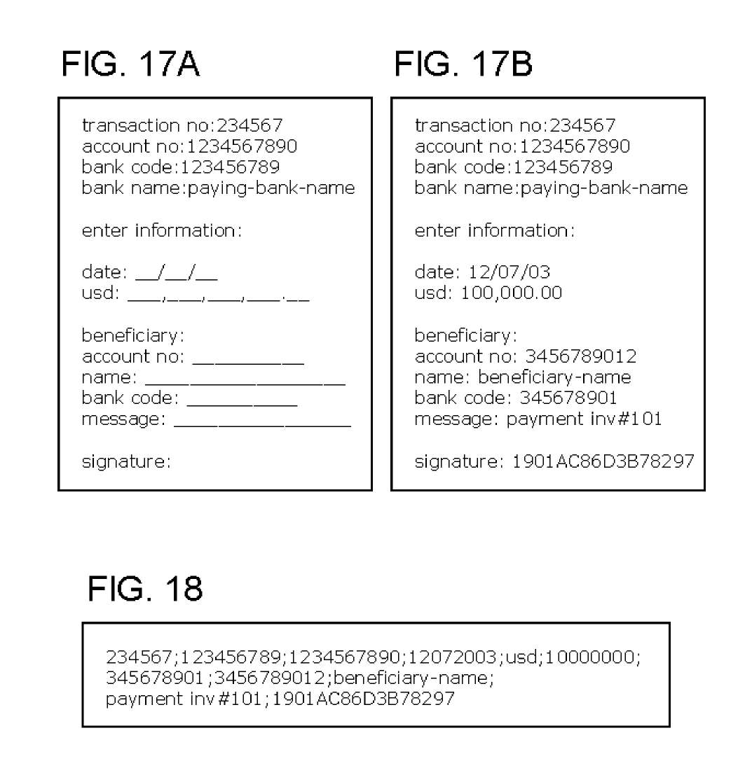

At Step 1520, upon receipt of the invoice 1601 from the payee 430, the payor 420 generates an electronic fund transfer request 1603 as follows, in order to pay the payee 430. The payor 420 activates the transaction module 240 of the payor apparatus 200 of FIG. 2, and selects the fund transfer application 245. The display module 210 of the apparatus 200 displays the information of FIG. 17A, to prompt the payor 420 to input the indicated information. The indicated information to be input by the payor can include the date, amount and beneficiary information, for example. The displayed data such as the transaction number, account number, bank code and bank name is all data which is pre-stored in the apparatus 200. Having input the required information, a digital signature of the payor 420 is generated by the signature generation means 242 based on the transaction number, the indicated information and the displayed data as described in more detail in U.S. patent application Ser. No. 10/604,885 (see above). FIG. 17B shows the display after the digital signature is generated and other information has been input.

At Step 1530, the generated electronic fund transfer request 1603 is transmitted from the payor 420 to the payor bank 410 to request that the bank performs an electronic fund transfer payment. FIG. 18 shows exemplary fund transfer request data transmitted from a payor apparatus 200 to the payor bank apparatus 300 of FIG. 3, in which the semicolon “;” symbol is used as a field separator.

At Step 1540, the received electronic fund transfer request 1603 from the payor 420 is verified by the payor bank 410 based on the transaction number and the digital signature of the payor 420.

At Step 1550, upon positive verification, the electronic fund transfer is then executed by the payor bank 410, by electronically transferring the requested amount of money (fund transfer settlement 1605) to the payee bank 440 in favor of the payee 430.

At Step 1560, upon completing the payment, the payor bank 410 debits the payor account and sends a debit notification 1607 to the payor 420. The payee bank 440 credits the payee account and sends a credit notification 1609 to the payee 430. The transaction is thereby completed.

Data transmission among the parties can be done through any electronic communication such as a wireless SMS (short messaging service), a wireless MMS (multimedia messaging service), an e-mail, or a computer-to-computer data transfer with standard/specific protocol, whichever is appropriate and practical.

Authentication of the user/payor prior to performing a transaction is necessary. And authentication of the user/payee prior to clearing a check is also necessary. The authentication can be done by means of PIN/password and/or biometric information.

In the above embodiments, the security of the transactions are enhanced by incorporating the transaction code 411 into the generation of the digital signatures described in U.S. patent application Ser. No. 10/604,885.

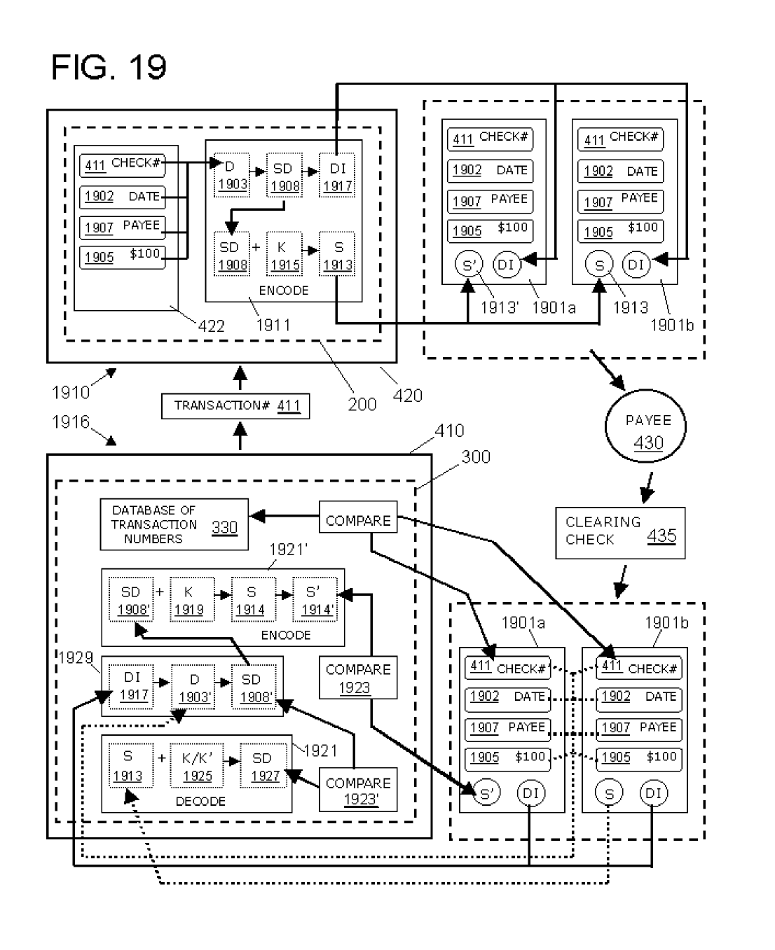

Referring now to FIG. 19, the paper check 422 has document data 1903 (represented by “D” in the figure) written on it. The document data, in the case of a check, can include a check date 1902, a check amount 1905, and a payee name 1907. All of the check data 1903 can be printed onto the check by the apparatus 200 of the customer 420. Alternatively, the check might be the electronic check 423 in which case the check data 1903 can be generally associated with the electronic check 423.

The transaction number 411, which in this case is a check number generated according to the present invention, is generated by the issuer or payor bank apparatus 300 along with other transaction numbers stored in the database of transaction numbers 330. The transaction number 411 is then supplied to the apparatus 200 to be included with the document data 1903.

A signature generation part 1911 of a signature generation section 1910 acquires (for example by optical character recognition or manual input) the document data “D” 903 from the check 422 and the acquired document data “D” 1903 is selected to produce selected document data “SD” 1908. The selected document data “SD” 1908 can be the same as or a subset of the document data “D” 1903 and includes the transaction number 411. A data indicator “DI” 1917 indicating which of the document data is used to generate a document signature 1913 is also generated. The generation part 1911 next generates the document signature “S” 1913 using a signor key “K” 1915 associated with a signor of the check 422 to encode the selected document data 1908.

The transaction number 411, data indicator 1917 and document signature 1913 are printed on the check 1901 (or associated with the check in the case of an electronic check 423) as indicated by the checks 1901a and 1901b. Other document data can also be added to the check 422. As shown in the figure, the check 422 can have a document signature S′ 1913 placed on it. Here S′ can include the entire generated document signature or just a portion of the document signature. Using just a portion of the signature has the advantage of saving processing time and making it easier and faster to place the document signature on the check 422, especially when the signature is to be written on the hardcopy document 1901 manually. The document signature S 1913 shown on the check 1901b, on the other hand, is the entire generated document signature.

Next, the check 422 is transferred to the payee 430 who in turn submits the check to a clearing step 435 using any of the methods described above.

The check 422 is submitted back to the payor bank apparatus 300 of the paying or payor bank 410 for verification.

In one embodiment, the check 1901a or 1901b is sent to a verification section 1916 of the issuer apparatus 300. The verification section 1916 verifies the transaction by performing a comparison between the issued transaction code 411 stored in the database 330 and the transaction code associated with the check. The payor bank apparatus 300 then flags or deletes the transaction code in the database upon positive verification of the transaction.

Also, a document data selection part 1929 of the verification section 1916 uses the data indicator 1917 read from the document 1901a to select the document data 1903′ to produce selected document data 1908′. The selected document data 1908′ is encoded by a encoding section 1921′. The encoding section 1921′ has a verification key 1919 corresponding to and substantially identical to the signor key 1915. The verification key 1919 is used to encode the selected document data 1908′ to produce an entire generated verification signature S 1914. Also, a verification signature S′ 1914′ can be produced which can include the entire generated verification signature or just a portion of the verification signature. A comparison part 1923 compares the verification signature S′ 1914′ to the document signature S′ 1913′ on the check 1901a, and if they are substantially the same then the document signature S′ 1913′ was generated using the authentic signor key 1915 and the selected document data 1908. Therefore, the document 1901a is authenticated using the results of the comparison. In this embodiment a symmetric cryptosystem such as DES can be used to encode the selected document data 1908, 1908′ to produce the signatures 1913′, 1914′, respectively.

In another embodiment, the signature 1913 placed on the check 422 must be substantially identical to the signature 1913 generated by the signature generation part 1911 as shown by the hardcopy document 1901b in the figure. The abbreviated signature of the previous embodiment should not be used. The hardcopy document 1901b is sent to the verification section 1916. A decoding section 1921 has a verification key K or K′ 1925. The document signature S 1913 is decoded using the verification key K or K′ 1925 to produce recovered selected document data SD 1927. The verification key K 1925 can be the same as the signor key 1915 as is the verification key K 1919 in the previous embodiment, or can be different from the signor key 1915 in which case it is referred to as verification key K′ 1925.

In this embodiment either a symmetric or an asymmetric cryptosystem can be used. When a symmetric cryptosystem such as DES is used, the signor key K 1915 and verification key K 1925 are substantially the same, and the selected document data 1908 and 1927 can be encoded and recovered using the same key. When an asymmetric cryptosystem such as RSA is used, the signor key K 1915 and verification key K′ 1925 are different, but related to one another. In this case the signor key K1915 can be regarded as a private key and the verification key K′ 1925 can be regarded as a public key. The signor key 1915 can be used to encode the selected document data 1908 to produce the document signature 1913 and the verification key K′ 1925 can be used to decode the document signature 1913 to recover the selected document data 1927. Also, the document data selection part 1929 uses the data indicator 1917 acquired from the document 1901b to select the document data 1903′ to produce the selected document data 1908′. A comparison part 1923′ compares the recovered document data 1927 to the selected document data 1908′. If the comparison shows that the recovered document data 1927 is substantially the same as the selected document data 1908′, then the document signature S 1913 was generated using the authentic signor key 1915 and the selected document data 1908. Therefore, the document 1901b is authenticated using the results of the comparison.

A hashing operation can be performed on the data, if necessary, to generate a message digest for the generation of the digital signature. A symmetric cryptosystem such as DES or 3DES can be employed to allow the use of only a portion of a generated digital signature in order to shorten the length of the signature required for check data, which is especially useful if the check is to be transmitted through SMS.

The clearing agent is not mentioned in the figures and descriptions for the sake of brevity and simplicity, but one skilled in the art understands the role of a clearing agent.

The present invention may be embodied in other forms without departing from its spirit and scope. The embodiments described above are therefore illustrative and not restrictive, since the scope of the invention is determined by the appended claims rather then by the foregoing description, and all changes that fall within the meaning and range of equivalency of the claims are to be embraced within their scope.

1. A system for performing transactions using transaction codes comprising:
an issuer apparatus for issuing a transaction code to a customer and storing the issued transaction code in a database;
a transaction apparatus for associating the transaction code with a document to perform a transaction and for performing the transaction using the document with the associated transaction code; and
a verification means of the issuer apparatus for verifying the transaction by performing a comparison between the issued transaction code stored in the database and the transaction code associated with the document, the issuer apparatus modifying the transaction code in the database after positive verification of the transaction.

2. The system of claim 1 wherein the transaction apparatus is a portable handheld device comprising a display module and transaction module.

3. The system of claim 2 wherein the transaction module includes:
a transaction code storage means for storing issued transaction codes; and
a signature generation means for generating a document signature by encoding the transaction code along with document data required to be associated with the document and wherein the transaction code and the document signature are then associated with the document; and
a data indicator associated with the document and indicating which of the document data is used to generate the document signature.

4. The system of claim 3 wherein the transaction apparatus includes a printer for printing the transaction code and the document signature onto the document.

5. The system of claim 1 wherein the transaction codes are unique for each particular type of transaction performed by a particular customer.

6. The system of claim 5 wherein the transaction codes are consecutive.

7. The system of claim 5 wherein the document is a hard-copy document.

8. The system of claim 5 wherein the document is a hard-copy check.

9. The system of claim 5 wherein the document is a piece of paper without customer-specific information printed thereon.

10. The system of claim 9 wherein a document signature and the transaction code are written on the piece of paper without customer-specific information, thereby changing the piece of paper into a document corresponding to a particular customer.

11. The system of claim 10 wherein the document corresponding to a particular customer is a check.

12. The system of claim 11 wherein the transaction apparatus is a portable handheld device comprising a display module and transaction module, the transaction module including a transaction code storage means for storing issued transaction codes and a signature generation means for generating the document signature and wherein the transaction code and document signature are copied by the customer from the display module and written on the piece of paper changing the piece of paper into a document corresponding to the particular customer.

13. The system of claim 11 wherein the transaction apparatus is a portable handheld device comprising:
a transaction code storage means for storing issued transaction codes;
a signature generation means for generating the document signature; and
a printer for printing the transaction code and the document signature onto the piece of paper thereby changing the piece of paper into a document corresponding to the particular customer.

14. The system of claim 11 wherein the transaction code is a check number.

15. The system of claim 11, wherein the transaction is the payment of a bill.

16. The system of claim 5 wherein the document is an electronic document.

17. The system of claim 5 wherein the document is an electronic check.

18. The system of claim 17 wherein the transaction apparatus comprises:
a transaction code storage means for storing issued transaction codes;
a display module for displaying pre-stored data including a transaction code and pre-stored data selected from the set consisting of: account number, account name, and routing number; and the display module also displaying a prompt for the customer to input indicated information selected from the set consisting of: date, payee and amount;
a signature generation means for generating a document signature by encoding the transaction code along with the pre-stored data and the indicated information; and
a data indicator associated with the document and indicating which of the document data is used to generate the document signature.

19. The system of claim 1 wherein the issuer apparatus issues the transaction code to the customer via SMS or MMS.

20. The system of claim 1 wherein the issuer apparatus modifies the transaction code in the database after verifying the transaction by removing the transaction code from the database or by flagging the transaction code in the database.

21. The system of claim 1 wherein the issuer apparatus is associated with an issuer bank.

22. The system of claim 21 further comprising a payee apparatus associated with a payee for receiving the document with the associated transaction code from the transaction apparatus and for forwarding the document to the issuer bank.

23. The system of claim 22 wherein the payee apparatus forwards the document to the issuer bank by clearing the document through a payee bank used by the payee.

24. The system of claim 22 wherein the payee apparatus forwards the document to the issuer bank by clearing the document through an ATM machine by manually entering at least part of the transaction data into the ATM machine.

25. The system of claim 22 wherein the payee verifies fund availability of the customer through the issuer bank prior to formally accepting the document and prior to the customer notifying the issuer bank to activate the document to allow payment to the payee.

26. The system of claim 23 wherein the clearing includes authenticating the identity of the payee.

27. The system of claim 3 wherein the issuer apparatus is associated with an issuer bank and the document is a fund transfer request to the issuer bank.

28. The system of claim 1, wherein the database is a database of the issuer apparatus.

29. The system of claim 1, wherein the database is a database of the transaction apparatus.

30. The system of claim 28, wherein the issuer apparatus generates the transaction code by applying a mathematical formula to a reference code and wherein the issuer apparatus stores the reference code in the database of the issuer apparatus without storing the issued transaction code in the database of the issuer apparatus.

31. The system of claim 30, wherein the reference code includes an account number of the customer.

32. A method for performing transactions using transaction codes comprising the steps of:
issuing transaction codes which are unique for particular types of transactions to a customer;
storing the issued transaction codes in a database;
selecting a transaction code from the issued transaction codes;
associating the transaction code with a document to perform a transaction;
performing the transaction using the document with the associated transaction code;
verifying the transaction by performing a comparison between the issued transaction code stored in the database and the transaction code associated with the document; and
modifying the transaction code in the database after positive verification of the transaction.
